(19) United States
(12) Patent Application Publication
(10) Pub. No.: US 2019/0143922 A1
(43) Pub. Date: May 16, 2019

(54) VEHICLE BUMPER

(71) Applicant: Janusz Chuptys CONTISSI, Debica (PL)

(72) Inventor: Piotr CHUPTYS, Debica (PL)

(73) Assignee: Janusz Chuptys CONTISSI, Debica (PL)

(21) Appl. No.: 16/182,884

(22) Filed: Nov. 7, 2018

(30) Foreign Application Priority Data
Nov. 13, 2017 (PL) P.423435

(51) Int. Cl. B60R 19/50; B60R 19/03

(52) U.S. Cl. CPC B60R 19/50; B60R 2019/505; B60R 19/03

(57) ABSTRACT

A bumper for vehicles mounted to the front or to the rear of a vehicle comprising a bumper beam made of a plastic which is characterised in that the bumper beam (2) together with a shield (3) of a lamp (4) constitutes a single monolith made of a plastic with translucency from 10% to 100%.

### FIELD OF THE INVENTION

The subject of the invention is a bumper for vehicles, especially for motor cars.

### BACKGROUND OF THE ART

The motor car bumpers are the most forward and backward components of the vehicle body. Materials most commonly used to manufacture bumpers include polypropylene (PP), polycarbonates (PC), and polyurethane (PUR), however they must be painted several times before assembling in the car which increases significantly the manufacturing cost.

Apart from protection against effects of a collision, a bumper performs also aesthetic role emphasizing positive aspects of appearance of motor car. Bumper is also the car component in which such other elements are mounted as halogen headlights, indicator lamps, headlamps, air intakes, registration number plates, and other elements.

A commonly known bumper comprises a rear metal plate attached to the front or to the rear of a vehicle. The rear plate supports a bumper segment which comprises a front plate as well as an upper wall and a lower wall. Rear ends of the upper wall and the lower wall are situated and fixed in slits provided in the plate. Moreover, a plurality of bumper ribs, substantially C-shaped, are arranged along the segment length and stick out backwards from the front plate and along the upper wall and the lower wall of the segment. The bumper has also upper and lower wings with reinforcement ribs protruding from them towards the upper wall and the lower wall. The wings constitute an aesthetic component and have virtually no effect on the energy absorption characteristics of bumper.

A motor car bumper known from protection description of the utility model No. RU054554 comprises a bumper beam and two brackets connected with said beam to fix it to the load-bearing structure of the car, said brackets made in the form of laminar structures. Transverse cross-section of each of the laminar structures comprises a core and a shell surrounding the core, whereas thickness of the shield is small relative to thickness of the core; further, the core is made of a porous material, and the shield is made of a thin sheet metal. The bumper is of the absorption type and its function consists in providing protection to motor car bodies against impact.

Commonly known bumpers, in view of the materials used to manufacture them, make joining them with the shield of motor car lighting lamp shield impossible.

### SUMMARY OF THE INVENTION

The objective of the present invention is to provide a bumper with a versatile, inexpensive, and simple structure which, together with the motor car lighting lamp shield, would constitute a single monolith increasing visibility of vehicle in the course of the use.

The subject-matter of the vehicle bumper according to the invention consists in that its bumper beam together with the headlight constitutes a single monolith made entirely of a plastic with translucency ranging from 10% to 100%. Translucency of the bumper ranges favourable from 10% to 100%, and translucency of the lamp shield ranges from 70% to 100%. It is also favourable when the bumper beam with the shield is made of a plastic, preferably polyethylene or polypropylene or PET. It is also favourable when a fluorescent or a reflexive coating is deposited on inner surface of the bumper beam.

### BRIEF DESCRIPTION OF THE DRAWINGS

FIG. 1 shows a perspective front view of a vehicle body with a bumper according to the present invention mounted on it;

FIG. 2 shows a side view of the mounted bumper with a fragment of side portion of vehicle body of FIG. 1; and

FIG. 3 shows a cross sectional view of bumper of FIG. 1 taken along line A-A.

### DETAILED DESCRIPTION OF THE INVENTION

The process of manufacturing traditional vehicle bumpers is expensive because it requires application of several paint coats, while the bumper according to the invention made of plastics with high translucency such as polyethylene, polypropylene, or PET, will allow to avoid expenses related to painting which would contribute significantly to reduction of the manufacturing cost, and moreover, by integrating the bumper beam with the lamp shield into one transparent monolith, it will be possible to contribute positively to the art of modern vehicle design. The bumper can be installed in all models of motor cars in which the bumper beam is in contact with lamp housings both in the front and in the rear of the vehicle.

Moreover, the vehicle bumper according to the invention, as an article manufactured of plastics with high translucency, will contribute to safety of participants of the road traffic as in case of riding a vehicle with headlights switched on, the light will be transmitted through the lamp shield onto large surface of the bumper improving therefore its visibility.

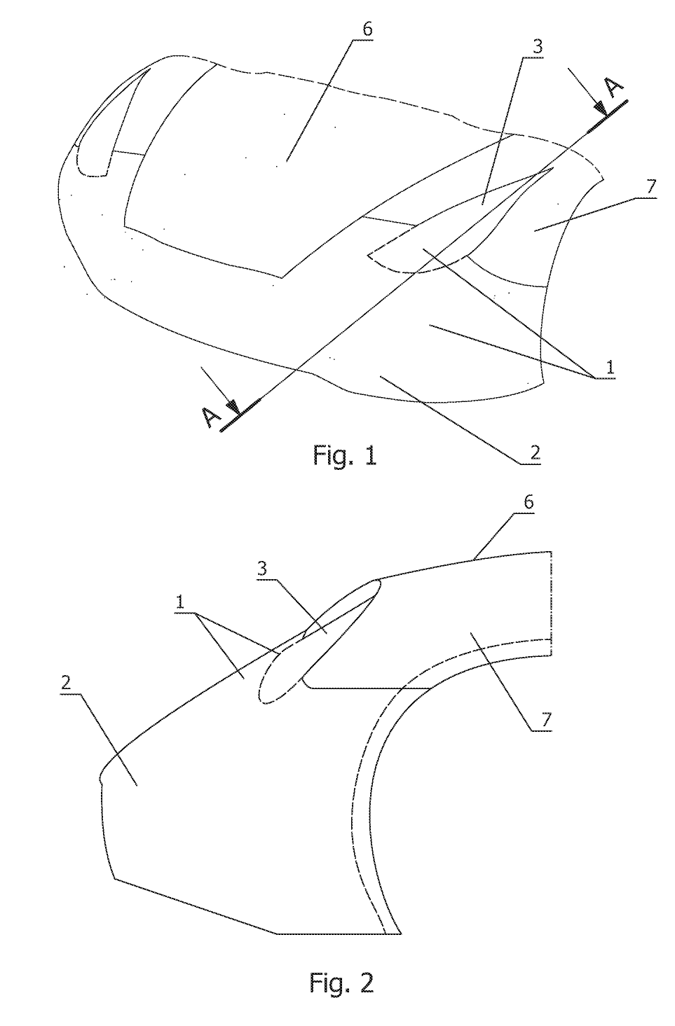

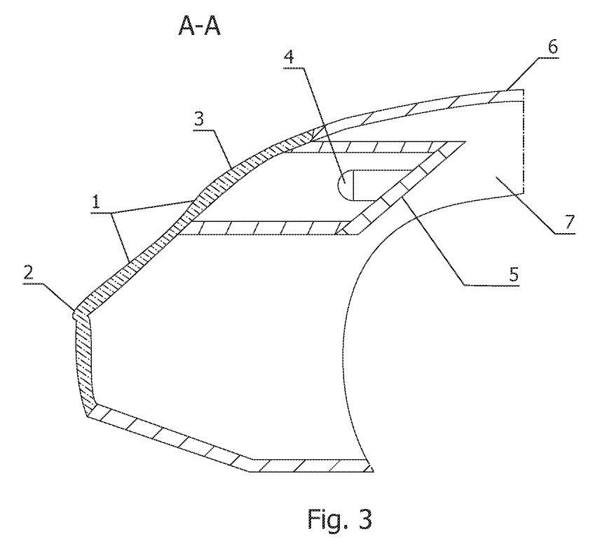

The subject of the invention is presented in example embodiment shown in schematic drawings, of which FIG. 1 shows a fragment of front portion of a vehicle body with the bumper mounted on it, in a isometric view; FIG. 2—the mounted bumper with a fragment of side portion of vehicle body, in a side view; and FIG. 3—the same bumper in vertical cross-section along line A-A.

### EXAMPLE 1

The vehicle bumper 1 shown in FIGS. 1-3 comprises a profiled bumper beam 2 constituting a single monolith with a shield 3 of lamp 4 situated in its seat 5. The bumper is made of polyethylene with translucency of 100% and is mounted by means of any known method to supporting structure of the vehicle either in the front or in the rear so that the central portion of the bumper beam 2 adheres to the hood 6 of the vehicle and side portions of the bumper beam adhere to side portions 7 of the vehicle body.

### EXAMPLE 2

In the second example embodiment, the vehicle bumper 1 has a structure analogous to this described in Example 1, and the difference consists in that the bumper beam 2 is made of a plastic of the type of polyethylene with translucency of 70%.

### EXAMPLE 3

In the third example embodiment, the vehicle bumper 1 has a structure analogous to this described in Example 1, and the difference consists in that the bumper beam 2 is made of a plastic of the type of PET with translucency of 10% whereas the shield 3 of the lamp 4 is made of a plastic with translucency of 100%.

### EXAMPLE 4

In the fourth example embodiment, the vehicle bumper 1 has a structure analogous to this described in Example 1, and the difference consists in that the bumper beam 2 is made of a plastic with translucency of 70%, whereas the shield 3 of the lamp 4 is made of a plastic with translucency of 95%.

In other example embodiments, not shown in drawings, a commonly known fluorescent or reflexive layer was deposited on inner side of the bumper beam 2 increasing additionally the overall visibility of the vehicle.

In further example embodiments, not shown in drawings, the bumper is additionally provided with typical elements and recesses to enable air inflow to vehicle cooler and attach the vehicle registration plate.

Moreover, it is obvious for the person skilled in the art that also other plastics can be used for making the bumper according to the invention provided that the translucency from 10% to 100% will be maintained.

1. A vehicle bumper adapted to be mounted in a front end or at a rear end of a vehicle, said vehicle bumper comprising:
a bumper beam made of a plastic, the bumper beam (2) together with a shield (3) of a lamp (4) constitutes a single monolith made of a plastic with translucency from 10% to 100%.

2. The bumper according to claim 1, wherein the translucency of the bumper beam (2) is from 10% to 100%, and a translucency of the shield (3) is from 70% to 100%.

3. The bumper according to claim 1, wherein the bumper beam (2) together with the shield (3) is made of a plastic including polyethylene, polypropylene or polyethylene terephthalate (PET).

4. The bumper according to claim 1, wherein the bumper beam (2) is provided with a fluorescent or a reflective layer.
